(19) United States
(12) Patent Application Publication
(10) Pub. No.: US 2008/0117789 A1
(43) Pub. Date: May 22, 2008

(54) OPTICAL PICKUP DEVICE

(75) Inventors: Taizoh Yokota, Higashihiroshima-shi (JP); Osamu Miyazaki, Mihara-shi (JP); Yasuo Nakata, Mihara-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka- shi (JP)

(21) Appl. No.: 11/940,796

(22) Filed: Nov. 15, 2007

(30) Foreign Application Priority Data
Nov. 17, 2006 (JP) 2006-311639

(51) Int. Cl. G11B 7/135; G11B 7/00

(52) U.S. Cl. 369/112.01; 369/121

(57) ABSTRACT

In the optical pickup device, a luminous flux emitted from a blue-violet laser as S wave to a blue-violet PBS, passes through a half-wave plate, and is reflected by the blue-violet PBS and a total reflection mirror, before being applied to a BD disc via an objective lens. Luminous fluxes, which were emitted respectively from an infrared laser emitting device and a red laser emitting device and were reflected respectively by infrared and red PBSs, among aligned infrared, red and blue-violets PBSs, before reaching the blue-violet PBS, are reflected by the blue-violet PBS. The luminous fluxes emitted from the blue-violet laser emitting device as P waves pass the blue-violet PBS, and are respectively applied to a CD disc, a DVD disc, or a HD-DVD disc via an diffractive object lens. Thus, it becomes possible to write or read access to four kinds of discs with three wavelengths.

### CROSS-REFERENCE TO RELATED APPLICATIONS

This nonprovisional application claims priority under 35 U.S.C. §119(a) on Patent Application No(s). 2006-311639 filed in Japan on Nov. 17, 2006, the entire contents of which are hereby incorporated by reference.

### BACKGROUND OF THE INVENTION

The present invention relates to an optical pickup device which optically records information on and reproduces the information from a disc-shaped recording medium.

As optical discs for optical reading of signals with use of light beams such as laser beams, CDs (Compact Discs) which have the thickest transparent cover at the side of signal reading (light incidence side) and which are adapted for recording and reproduction of information with use of a light source emitting infrared laser beams are popular. In response to the needs for higher capacity, high density discs which have the same disc diameter as CDs to ensure structural compatibility and which further support recording in density higher than CDs to achieve higher capacity have been proposed. These discs include DVDs (Digital Versatile Discs) which have the transparent cover at the side of signal reading thinner than that of the CDs and which are adapted for recording and reproduction of information with use of a light source emitting red laser beams, super high density BDs (Blu-ray Discs) which have the transparent cover at the side of signal reading thinner than that of the DVDs and which are adapted for recording and reproduction of information with use of a light source which emits blue-violet laser beams having shorter wavelengths, and HD-DVDs (High Definition DVDs) which have the transparent cover at the side of signal reading (light incidence side) thinner than that of the CDs and thicker than that of the BDs, and which are adapted for recording and reproduction of information with use of a light source emitting blue-violet laser beams.

In order to enable optical pickup devices to read three kinds of signals different in wavelengths, that is, signals from CDs, DVDs which are high-density discs, and BDs or HD-DVDs which are super-high-density discs, laser diodes which emit light beams in three kinds of wavelengths and optical systems which support three kinds of wavelengths are necessary, and therefore it is required to switch the light sources and the optical systems for use in response to the recording density of recording media subjected to signal reading. For example, the pickups, which support three kinds of discs, including BDs, DVDs and CD, as well as HD-DVDs, DVDs and CDs, can be structured by taking advantage of the point that three kinds of wavelengths in use are different from each other (e.g., JP 2005-353259 A, JP 2005-353250 A, and JP 2006-40411 A).

However, the conventional optical pickups structured by taking advantage of the point that three kinds of wavelengths in use are different from each other have the following problems.

That is, the BDs and the HD-DVDs subject to use of blue-violet laser having the shortest wavelength are different in the thickness of the transparent cover layer at the side of the signal reading (light incidence side) in the optical disc, so that it is difficult to record information on and to reproduce information from the BDs and the HD-DVDs by the same optical pickup. In short, it is difficult to record information on and to reproduce information from all the discs including CDs, DVDs, HD-DVDs and BDs with the same optical pickup.

Accordingly, it is necessary to prepare separate optical pickups, an optical pickup corresponding to BDs (DVDs, CDs), and an optical pickup corresponding to HD-DVDs (DVDs, CDs), and therefore two drive devices are necessary for performing recording and reproduction operation in both the BDs and the HD-DVDs. This causes a problem of increase in size and costs of the entire product.

### SUMMARY OF THE INVENTION

An object of the present invention is to provide an optical pickup which can record information on and reproduce information from four kinds of discs with three wavelengths, or an optical pickup which can record information on and reproduce information from both the BDs and the HD-DVDs.

In order to achieve the above object, there is provided an optical pickup device, comprising:

a first light source for emitting a first wavelength laser beam to a disc-shaped first recording medium which is subjected to recording and reproduction of information with the first wavelength laser beam;

a second light source for emitting a second wavelength laser beam to a disc-shaped second recording medium which is subjected to recording and reproduction of information with the second wavelength laser beam;

a third light source for emitting a third wavelength laser beam to a disc-shaped third recording medium which is subjected to recording and reproduction of information with the third wavelength laser beam and to a disc-shaped fourth recording medium which is subjected to recording and reproduction of information with the third wavelength laser beam;

a first optical system for guiding the first wavelength laser beam emitted from the first light source to the first recording medium;

a second optical system for guiding the second wavelength laser beam emitted from the second light source to the second recording medium;

a polarization beam splitter having a polarization beam splitting function for splitting the third wavelength laser beam and a dichroic function with wavelength selectivity for the first wavelength laser beam and the second wavelength laser beam, the polarization beam splitter splitting an optical path of the third wavelength laser emitted from the third light source into a first optical path going to the third recording medium and a second optical path going to the fourth recording medium; and

a polarizing orientation switchover element which is placed on an optical axis between the third light source and the polarization beam splitter for rotating a polarization direction of the third wavelength laser beam emitted from the third light source 90 degrees, and splitting a luminous flux of the third wavelength laser beam into either the first optical path or the second optical path with the polarization beam splitter, wherein with light beams of three wavelengths including the first wavelength laser beam from the first light source, the second wavelength laser beam from the second light source and the third wavelength laser beam from the third light source, information can be recorded on and reproduced from four kinds of disc-shaped recording media including the first recording medium, the second recording medium, the third recording medium and the fourth recording medium.

According to the above structure, the optical pickup device includes a polarization beam splitter having a polarization beam splitting function for splitting the third wavelength laser beam, and a dichroic function with wavelength selectivity for the first wavelength laser beam and the second wavelength laser beam, for splitting the optical path of the third wavelength laser from the third light source into a first optical path and a second optical path, and a polarizing orientation switchover element for rotating the polarization direction of the third wavelength laser beam from the third light source 90 degrees so that the polarization beam splitter splits the optical path of the third wavelength laser beam into either the first optical path side or the second optical path side. Consequently, depending on the use and non-use of the polarizing orientation switchover element, it becomes possible to record information on and reproduce information from the fourth recording medium with the thinnest transparent cover at the side of signal reading and the third recording medium with the transparent cover at the side of signal reading thicker than that of the fourth recording medium with use of one wavelength of the third wavelength laser beam from the third light source.

Therefore, by using the first optical system for guiding the first wavelength laser beam emitted from the first light source to the first recording medium having the thickest transparent cover at the side of signal reading in combination with the second optical system for guiding the second wavelength laser beam emitted from the second light source to the second recording medium having the transparent cover at the side of signal reading thinner than that of the first recording medium, it becomes possible to record information on and reproduce information from four kinds of disc-shaped recording media with use of light beams of three wavelengths.

In one embodiment of the invention, the optical pickup device further comprises a polarizing orientation switchover element moving mechanism which inserts and extracts the polarizing orientation switchover element.

According to this embodiment, the polarizing orientation switchover element is inserted into and extracted from between the third light source and the polarization beam splitter by the polarizing orientation switchover element moving mechanism depending on which recording medium, the third recording medium or the fourth recording medium, is subjected to information recording and reproduction, so that with one wavelength of the third wavelength laser beam from the third light source, information can be recorded on and reproduced from the fourth recording medium with the thinnest transparent cover at the side of signal reading and the third recording medium with the transparent cover at the side of signal reading thicker than that of the fourth recording medium.

In one embodiment of the invention, the optical pickup device further comprises a plate glass or a transparent plate resin which is placed on an optical axis between the third light source and the polarization beam splitter, and which has a thickness optically equivalent to the polarizing orientation switchover element, and a plate moving mechanism for extractably inserting the plate glass or the transparent plate resin into a position where the polarizing orientation switchover element was present between the third light source and the polarization beam splitter after the polarizing orientation switchover element is extracted from the position blocking the optical axis.

According to this embodiment, a plate glass or a plate resin is extractably inserted into the position where the polarizing orientation switchover element was present, after the polarizing orientation switchover element is extracted from the position which blocks the optical axis between the third light source and the polarization beam splitter, so that a stable and sufficient condensing spot can be obtained regardless of the presence of the polarizing orientation switchover element without changing the designed thickness of the cover glass of, for example, a collimate lens.

In one embodiment of the invention, the polarizing orientation switchover element is inserted by the polarizing orientation switchover element moving mechanism into a position blocking the optical axis between the third light source and the polarization beam splitter so as to rotate a polarization direction of the third wavelength laser beam emitted from the third light source 90 degrees, the polarization beam splitter splits the third wavelength laser beam with the polarization direction rotated 90 degrees by the polarizing orientation switchover element into the second optical path side which goes to the fourth recording medium, and the optical pickup device comprises an objective lens for the fourth recording medium for guiding a luminous flux of the third wavelength laser beam split to the second optical path side by the polarization beam splitter to the fourth recording medium, so that with the third wavelength laser beam emitted from the third light source, information is recorded on and reproduced from the fourth recording medium.

According to this embodiment, the polarization direction of the third wavelength laser beam emitted from the third light source as, for example, a P wave toward the polarization beam splitter is rotated 90 degrees by the polarizing orientation switchover element inserted in between the third light source and the polarization beam splitter, so that the third wavelength laser beam is made to come incident into the polarization beam splitter as an S wave. The luminous flux of the third wavelength laser beam reflected by the polarization beam splitter and split from the first optical path is guided to the fourth recording medium through the objective lens, so that stable splitting characteristics can be obtained by making the polarization beam splitter reflect the S wave.

In one embodiment of the invention, the polarizing orientation switchover element is extracted by the polarizing orientation switchover element moving mechanism from a position blocking the optical axis between the third light source and the polarization beam splitter so as to prevent a polarization direction of the third wavelength laser beam emitted from the third light source from changing, the polarization beam splitter splits the third wavelength laser beam with the polarization direction unchanged by the polarizing orientation switchover element into the first optical path side which goes to the third recording medium, and the optical pickup device comprises an objective lens for the third recording medium for guiding a luminous flux of the third wavelength laser beam split to the first optical path side by the polarization beam splitter to the third recording medium, so that with the third wavelength laser beam emitted from the third light source, information is recorded on and reproduced from the third recording medium.

According to this embodiment, the polarizing orientation switchover element is removed from between the third light source and the polarization beam splitter. Consequently, the third wavelength laser beam emitted from the third light source toward the polarization beam splitter, for example, as a P wave is made to come incident into the polarization beam splitter without changing its polarization direction, and the luminous flux of the third wavelength laser beam which passed through the polarization beam splitter and was split into the first optical path is guided to the third recording medium through the objective lens, so that stable splitting characteristics can be obtained by making the polarization beam splitter transmit the P wave.

In one embodiment of the invention, the polarizing orientation switchover element is extracted by the polarizing orientation switchover element moving mechanism from a position blocking the optical axis between the third light source and the polarization beam splitter so as to prevent a polarization direction of the third wavelength laser beam emitted from the third light source from changing, the polarization beam splitter splits the third wavelength laser beam with the polarization direction unchanged by the polarizing orientation switchover element into the second optical path side which goes to the fourth recording medium, and the optical pickup device comprises an objective lens for the fourth recording medium for guiding a luminous flux of the third wavelength laser beam split to the second optical path side by the polarization beam splitter to the fourth recording media, so that with the third wavelength laser beam emitted from the third light source, information is recorded on and reproduced from the fourth recording medium.

According to this embodiment, the polarizing orientation switchover element is removed from between the third light source and the polarization beam splitter. Consequently, the third wavelength laser beam emitted from the third light source, for example, as a P wave toward the polarization beam splitter is made to come incident into the polarization beam splitter without changing its polarization direction, and the luminous flux of the third wavelength laser beam which was reflected by the polarization beam splitter and split into the second optical path is guided to the fourth recording medium through the objective lens, so that stable splitting characteristics can be obtained by making the polarization beam splitter reflect the P wave.

In one embodiment of the invention, the polarizing orientation switchover element is inserted by the polarizing orientation switchover element moving mechanism into a position blocking the optical axis between the third light source and the polarization beam splitter so as to rotate a polarization direction of the third wavelength laser beam emitted from the third light source 90 degrees, the polarization beam splitter splits the third wavelength laser beam with the polarization direction rotated 90 degrees by the polarizing orientation switchover element into the first optical path side which goes to the third recording medium, and the optical pickup device comprises an objective lens for the third recording medium for guiding a luminous flux of the third wavelength laser beam split to the first optical path side by the polarization beam splitter to the third recording medium, so that with the third wavelength laser beam emitted from the third light source, information is recorded on and reproduced from the third recording medium.

According to this embodiment, the polarization direction of the third wavelength laser beam emitted from the third light source as, for example, a P wave toward the polarization beam splitter is rotated 90 degrees by the polarizing orientation switchover element inserted in between the third light source and the polarization beam splitter, so that the third wavelength laser beam is made to come incident into the polarization beam splitter as an S wave. The luminous flux of the third wavelength laser beam which passed through the polarization beam splitter and was split into the first optical path is guided to the third recording medium through the objective lens, so that stable splitting characteristics can be obtained by making the polarization beam splitter transmit the S wave.

In one embodiment of the invention, the first wavelength laser beam from the first light source is an infrared laser beam, the second wavelength laser beam emitted from the second light source is a red laser beam, and the third wavelength laser beam emitted from the third light source is a blue-violet laser beam.

According to this embodiment, the infrared laser beam with the longest wavelength is emitted from the first light source, the red laser beam with a medium wavelength is emitted from the second light source, and the blue-violet laser beam with the shortest wavelength is emitted from the third light source. Therefore, with the light beams of three wavelengths including the infrared laser beam, the red laser beam, and the blue-violet laser beam, information can be recorded on and reproduced from the four kinds of disc-shaped recording media.

Also, there is provided an optical pickup device, comprising:

a light source for emitting a blue-violet laser beam to a disc-shaped first recording medium which is subjected to recording and reproduction of information with the blue-violet laser beam and to a disc-shaped second recording medium which is subjected to recording and reproduction of information with the blue-violet wavelength laser beam;

a first objective lens for guiding the blue-violet laser beam emitted from the light source to the first recording medium;

a second objective lens for guiding the blue-violet laser beam emitted from the light source to the second recording medium;

a half mirror for splitting the blue-violet laser beam emitted from the light source into a first optical path in which the blue-violet laser beam passes toward the first objective lens side, and a second optical path in which the blue-violet laser beam is reflected toward the second objective lens; and

a reflective mirror for reflecting the blue-violet laser beam split to the first optical path side by the half mirror toward the first objective lens,

wherein with one wavelength of the blue-violet laser beam from the light source, information can be recorded on and reproduced from two kinds of disc-shaped recording media including the first recording medium and the second recording medium.

According to the structure, the blue-violet laser beam emitted from the light source is split by the half mirror to the first optical path in which the blue-violet laser beam passes toward the first objective lens and to the second optical path in which the blue-violet laser beam is reflected toward the second objective lens, and the blue-violet laser beam reflected toward the second objective lens is guided to the second recording medium via the second objective lens, while the blue-violet laser beam which passed toward the first objective lens is reflected by the reflective mirror toward the first objective lens side and is guided to the first recording medium via the first objective lens, so that with one wavelength of the blue-violet laser beam from the light source, information can be recorded on and reproduced from the first recording medium having the thinnest transparent cover at the side of signal reading and the second recording medium with the transparent cover at the side of signal reading thicker than that of the first recording medium.

Therefore, by using the first optical system for guiding the infrared laser beam emitted from the second light source to the third recording medium having the thickest transparent cover at the side of signal reading and the second optical system for guiding the red laser beam emitted from the third light source to the fourth recording medium having the transparent cover at the side of signal reading thinner than that of the third recording medium in combination with the above optical pickup device including the light source for emitting the blue-violet laser beam, it becomes possible to record information on and reproduce information from four kinds of disc-shaped recording media with use of light beams of three wavelengths.

Also, there is provided an optical pickup device, comprising:

a light source for emitting a blue-violet laser beam to a disc-shaped first recording medium which is subjected to recording and reproduction of information with the blue-violet laser beam and to a disc-shaped second recording medium which is subjected to recording and reproduction of information with the blue-violet wavelength laser beam;

a first objective lens for guiding the blue-violet laser beam emitted from the light source to the first recording medium;

a second objective lens for guiding the blue-violet laser beam emitted from the light source to the second recording medium;

a half mirror for splitting the blue-violet laser beam emitted from the light source into a first optical path in which the blue-violet laser beam passes toward the second objective lens side, and a second optical path in which the blue-violet laser beam is reflected toward the first objective lens; and

a reflective mirror for reflecting the blue-violet laser beam split to the first optical path side by the half mirror toward the second objective lens,

wherein with one wavelength of the blue-violet laser beam from the light source, information can be recorded on and reproduced from two kinds of disc-shaped recording media including the first recording medium and the second recording medium.

According to the structure, the blue-violet laser beam emitted from the light source is split by the half mirror to the first optical path in which the blue-violet laser beam passes toward the second objective lens and to the second optical path in which the blue-violet laser beam is reflected toward the first objective lens, and the blue-violet laser beam reflected toward the first objective lens is guided to the first recording medium via the first objective lens, while the blue-violet laser beam which passed toward the second objective lens is reflected by the reflective mirror toward the second objective lens side and is guided to the second recording medium via the second objective lens, so that with one wavelength of the blue-violet laser beam from the light source, information can be recorded on and reproduced from the first recording medium having the thinnest transparent cover at the side of signal reading and the second recording medium with the transparent cover at the side of signal reading thicker than that of the first recording medium.

Therefore, by using the first optical system for guiding the infrared laser beam emitted from the second light source to the third recording medium having the thickest transparent cover at the side of signal reading and the second optical system for guiding the red laser beam emitted from the third light source to the fourth recording medium having the transparent cover at the side of signal reading thinner than that of the third recording medium in combination with the above optical pickup device including the light source for emitting the blue-violet laser beam, it becomes possible to record information on and reproduce information from four kinds of disc-shaped recording media with use of light beams of three wavelengths.

In one embodiment of the invention, the first objective lens is an objective lens dedicated for the first recording medium, and the second objective lens is a diffractive object lens which can support the second recording medium, a disc-shaped third recording medium which has a thickest transparent cover at a side of signal reading and which is subjected to recording and reproduction of information with a infrared laser beam, and a disc-shaped fourth recording medium which has a transparent cover at a side of signal reading thinner than that of the third recording medium and which is subjected to recording and reproduction of information with a red laser beam.

According to this embodiment, since the second objective lens is constituted from a diffractive object lens which can support the third recording medium and the fourth recording medium in addition to the second recording medium, when this diffractive object lens is included as a constituent of the first optical system for guiding the infrared laser beam emitted from the second light source to the third recording medium and the second optical system for guiding the red laser beam emitted from the third light source to the fourth recording medium, it becomes possible to record information on and reproduce information from four kinds of disc-shaped recording media with light beams of three wavelengths with a low cost structure without needing a complicated mechanism.

In one embodiment of the invention, when a recording medium which is a destination of the blue-violet laser beam reflected by the half mirror is a recording medium for reproduction only and the other recording medium is a recording medium for reproduction and recording, the half mirror is so set that reflectance is lower than transmittance, and when a recording medium which is a destination of the blue-violet laser beam reflected by the half mirror is a recording medium for reproduction and recording and the other recording medium is a recording medium for reproduction only, the half mirror is so set that reflectance is higher than transmittance.

According to this embodiment, when one of two recording media, which are destinations of two optical paths split by the half mirror, is a recording medium for reproduction only, the quantity of the light beam split to the optical path leading to the recording medium for both reproduction and recording is increased, which makes it possible to avoid applying load on the laser power of the light source, and to accomplish the optical pickup device with less energy consumption.

As is clear from the above, the optical pickup device of the present invention has a polarizing orientation switchover element which is placed between the third light source and the polarization beam splitter for splitting the optical path of the third wavelength laser from the third light source into a first optical path and a second optical path, and which rotates the polarization direction of the third wavelength laser beam from the third light source 90 degrees. Consequently, depending on the use and non-use of the polarizing orientation switchover element, information can be recorded on and reproduced from the fourth recording medium and the third recording medium which are different in the thickness of the transparent cover at the side of signal reading with one wavelength of the third wavelength laser beam from the third light source.

Therefore, by using the first optical system for guiding the first wavelength laser beam emitted from the first light source to the first recording medium having the thickest transparent cover at the side of signal reading and the second optical system for guiding the second wavelength laser beam emitted from the second light source to the second recording medium having the transparent cover at the side of signal reading thinner than that of the first recording medium in combination with the above optical pickup device including the third light source, it becomes possible to record information on and reproduce information from four kinds of disc-shaped recording media with use of light beams of three wavelengths.

Also in the optical pickup device of the present invention, the blue-violet laser beam emitted from the light source is split by the half mirror to the first optical path in which the blue-violet laser beam passes toward the first objective lens and to the second optical path in which the blue-violet laser beam is reflected toward the second objective lens, and the blue-violet laser beam which passed toward the first objective lens is reflected by the reflective mirror toward the first objective lens, so that with one wavelength of the blue-violet laser beam from the light source, information can be recorded on and reproduced from the first recording medium having the thinnest transparent cover at the side of signal reading and the second recording medium having the transparent cover at the side of signal reading thicker than that of the first recording medium.

Therefore, by using the first optical system for guiding the infrared laser beam emitted from the second light source to the third recording medium having the thickest transparent cover at the side of signal reading and the second optical system for guiding the red laser beam emitted from the third light source to the fourth recording medium having the transparent cover at the side of signal reading thinner than that of the third recording medium in combination with the above optical pickup device including the light source for emitting the blue-violet laser beam, it becomes possible to record information on and reproduce information from four kinds of disc-shaped recording media with use of light beams of three wavelengths.

Also in the optical pickup device of the present invention, the blue-violet laser beam emitted from the light source is split by the half mirror to the first optical path in which the blue-violet laser beam passes toward the second objective lens and to the second optical path in which the blue-violet laser beam is reflected toward the first objective lens, and the blue-violet laser beam which passed toward the second objective lens is reflected by the reflective mirror toward the second objective lens, so that with one wavelength of the blue-violet laser beam from the light source, information can be recorded on and reproduced from the first recording medium having the thinnest transparent cover at the side of signal reading and the second recording medium having the transparent cover at the side of signal reading thicker than that of the first recording medium.

Therefore, by using the first optical system for guiding the infrared red laser beam emitted from the second light source to the third recording medium having the thickest transparent cover at the side of signal reading and the second optical system for guiding the red laser beam emitted from the third light source to the fourth recording medium having the transparent cover at the side of signal reading thinner than that of the third recording medium in combination with the above optical pickup device including the light source emitting the blue-violet laser beam, it becomes possible to record information on and reproduce information from four kinds of disc-shaped recording media with use of light beams of three wavelengths.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a view showing the structure of an optical pickup device in the present invention during operation involving BDs;

FIG. 2 is a view showing the patterns on a light receiving element in FIG. 1;

FIG. 3 is an explanatory view of the operation involving HD-DVDs in the optical pickup device shown in FIG. 1;

FIG. 4 is an explanatory view of the operation involving HD-DVDs different from that in FIG. 3;

FIG. 5 is an explanatory view of the operation involving DVDs in the optical pickup device shown in FIG. 1;

FIG. 6 is an explanatory view of the operation involving CDs in the optical pickup device shown in FIG. 1;

FIG. 7 is a plan view for explaining the operation involving BDs in an optical pickup device different from that in FIG. 1;

FIG. 8 is a side view in the optical pickup device shown in FIG. 7;

FIG. 9 is a plan view for explaining the operation involving HD-DVDs in the optical pickup device shown in FIG. 7;

FIG. 10 is a side view in the optical pickup device shown in FIG. 9;

FIG. 11 is a plan view in an optical pickup device different from those in FIGS. 1 and 7;

FIG. 12 is a side view in the optical pickup device shown in FIG. 11;

FIG. 13 is a side view for explaining the operation involving BDs in an optical pickup device different from those in FIGS. 1, 7, and 11;

FIG. 14 is a plan view in an optical pickup device shown in FIG. 13;

FIG. 15 is an explanatory view of the operation involving HD-DVDs in the optical pickup device shown in FIG. 13;

FIG. 16 is a plan view in an optical pickup device shown in FIG. 15;

FIG. 17 is a side view for explaining the operation involving BDs in an optical pickup device different from those in FIGS. 1, 7, 11, and 13;

FIG. 18 is a plan view in an optical pickup device shown in FIG. 17;

FIG. 19 is an explanatory view of the operation involving HD-DVDs in the optical pickup device shown in FIG. 17;

FIG. 20 is a plan view in an optical pickup device shown in FIG. 19;

FIG. 21 is an explanatory view of the operation involving CDs in the optical pickup device shown in FIG. 17;

FIG. 22 is a plan view in an optical pickup device shown in FIG. 21;

FIG. 23 is an explanatory view of the operation involving DVDs in the optical pickup device shown in FIG. 17;

FIG. 24 is a plan view in an optical pickup device shown in FIG. 23;

FIG. 25 is a side view for explaining the operation involving BDs in an optical pickup device different from those in FIGS. 1, 7, 11, 13, and 17;

FIG. 26 is a plan view in an optical pickup device shown in FIG. 25;

FIG. 27 is an explanatory view of the operation involving HD-DVDs in the optical pickup device shown in FIG. 25;

FIG. 28 is a plan view in an optical pickup device shown in FIG. 27.

### DETAILED DESCRIPTION OF THE INVENTION

Hereinbelow, the present invention will be described in details in conjunction with the embodiments with reference to the drawings.

### First Embodiment

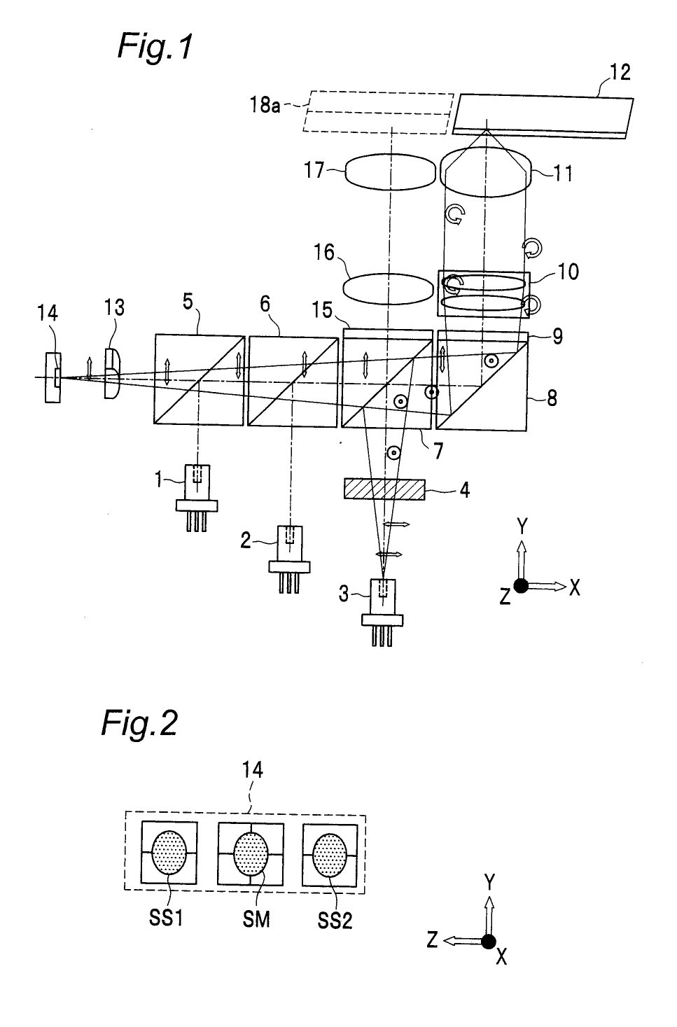

FIG. 1 is a view showing the structure of an optical pickup device of the present embodiment. In FIG. 1, there are an infrared laser emitting device 1 as the first light source, a red laser emitting device 2 as the second light source, and a blue-violet laser emitting device 3 as the third light source. Also, there are a half-wave plate 4 as the polarizing orientation switchover element having a moving mechanism which can insert the half-wave plate into and extract the same from a luminous flux, an infrared polarization beam splitter (hereinafter referred to as a PBS) 5 which is a prism having a polarization beam splitting function (hereinafter referred to as a PBS function) in an infrared wavelength band and a dichroic function for red and blue-violet colors, a red PBS 6 which is a prism having a PBS function in a red wavelength band and a dichroic function for infrared and blue-violet colors, and a blue-violet PBS 7 which is a prism having a PBS function in a blue-violet wavelength band and a dichroic function for infrared and red colors. The PBS function and dichroic function of the respective polarization PBSs 5, 6, and 7 are as follows. The infrared PBS 5 has a function of reflecting an infrared light P wave, transmitting an infrared light S wave, and transmitting red and blue-violet light. The red PBS 6 has a function of reflecting a red light P wave, transmitting a red light S wave, and transmitting infrared and blue-purple colors. The blue-violet PBS 7 has a function of transmitting a blue-violet light P wave, reflecting a blue-violet light S wave, and reflecting infrared and red light.

In FIG. 1, a luminous flux emitted from the blue-violet laser emitting device 3, which is a P wave relative to the blue-violet PBS 7, is subjected to 90 degree rotation of its polarization direction by the half-wave plate 4, so that the luminous flux comes incident to the blue-violet PBS 7 as an S wave. The luminous flux reflected by the PBS surface of the blue-violet PBS 7 is reflected by a total reflection mirror 8, and is converted into a circularly polarized beam by a quarter-wave plate 9, before being incident into a collimate lens 10 having an aberration correcting function to become a parallel beam. Further, the parallel beam is applied to a BD disc 12 via an objective lens 11, by which write or read access of a signal is performed.

The circularly polarized beam reflected from the BD disc 12, which has the rotation direction reverse to the direction before the reflection, is converted to a linearly polarized beam by the quarter-wave plate 9, and comes incident into the blue-violet PBS 7 as a P wave. Herein, the direction of the linearly polarized beam in this case is different from the direction of the original linearly polarized beam (at the time of incident) by 90 degrees. Then, the light beam which was incident into the blue-violet PBS 7 passes through the blue-violet PBS 7, the red PBS 6 and the infrared PBS 5, before going to a cylindrical lens 13, where a focus error signal is generated, and to a light receiving element 14, where an RF signal, a tracking error signal and a focus error signal are detected.

FIG. 2 is a view of expanded patterns on the light receiving element 14, showing the light receiving state of a general main beam and a sub beam. In FIG. 2, a push pull component of a main beam in the RF signal and the tracking error signal from the BD disc 12 is detected at a center spot SM. A push pull component of a sub beam in the tracking error signal is detected at a sub beam SS1 and a sub beam SS2.

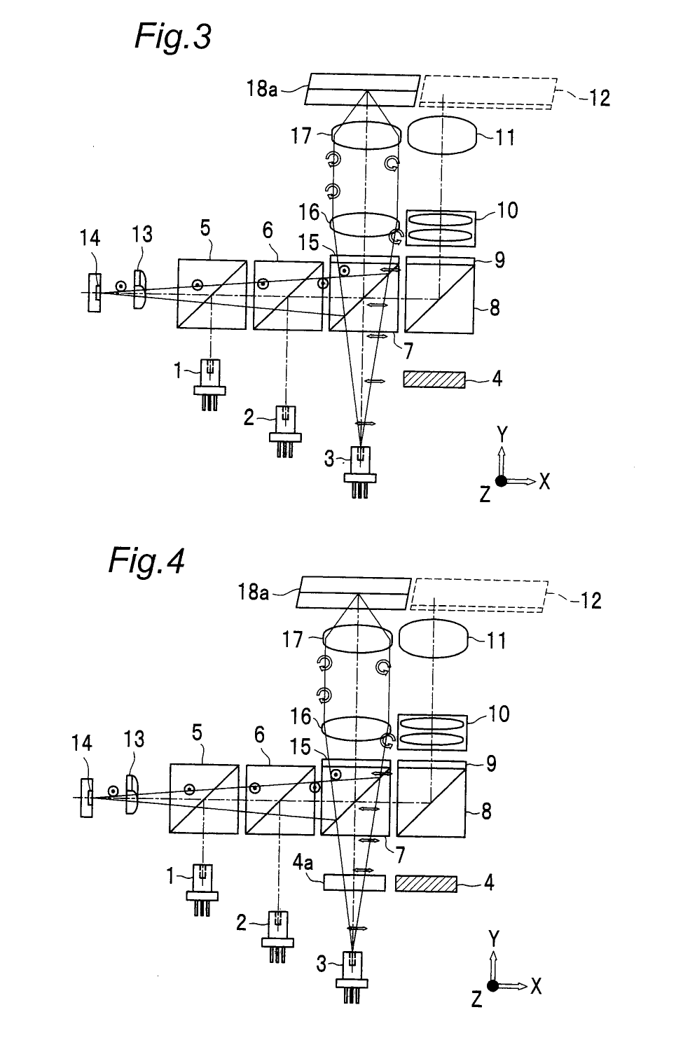

FIGS. 3 and 4 are views explaining the operation involving HD-DVDs. In FIG. 3, a luminous flux outgoing from the blue-violet laser emitting device 3, which is a P wave relative to blue-violet PBS 7, comes incident into the blue-violet PBS 7 with its P wave polarization direction intact since the half-wave plate 4 is out of the optical path. The luminous flux which passed through the PBS surface of the blue-violet PBS 7 as it was an P wave is converted into a circularly polarized beam by a quarter-wave plate 15, and is incident into the collimate lens 16, where it becomes a parallel beam. Further, the parallel beam is applied to a HD-DVD disc 18a via a diffractive object lens 17 which can support CDs, DVDs and HD-DVDs, by which write or read access of a signal is performed.

The circularly polarized beam reflected from the HD-DVD disc 18a, which has the rotation direction reverse to the direction before the reflection, is converted to a linearly polarized beam by the quarter-wave plate 15, and comes incident into the blue-violet PBS 7 as an S wave. It is to be noted that the direction of the linearly polarization in this case is different from the direction of the original linearly polarized beam (at the time of incident) by 90 degrees. Then, the light beam which was incident into the blue-violet PBS 7 is reflected by the blue-violet PBS 7, and passes through the red PBS 6 and the infrared PBS 5, before going to a cylindrical lens 13, where a focus error signal is generated, and to a light receiving element 14, where an RF signal, a tracking error signal and a focus error signal are detected.

FIG. 4 shows a modified example of the structure in FIG. 3, in which the half-wave plate 4 having a mechanism to insert it into and extract it from the luminous flux is removed from the luminous flux, and simultaneously a plate glass or a plate resin 4a having a thickness optically equivalent to the half-wave plate 4 is inserted into the luminous flux at a position where the half-wave plate 4 was present. Thus, it becomes possible to guide a sufficient parallel beam to the diffractive object lens 17, without changing the aberration correction amount in the collimate lens 16.

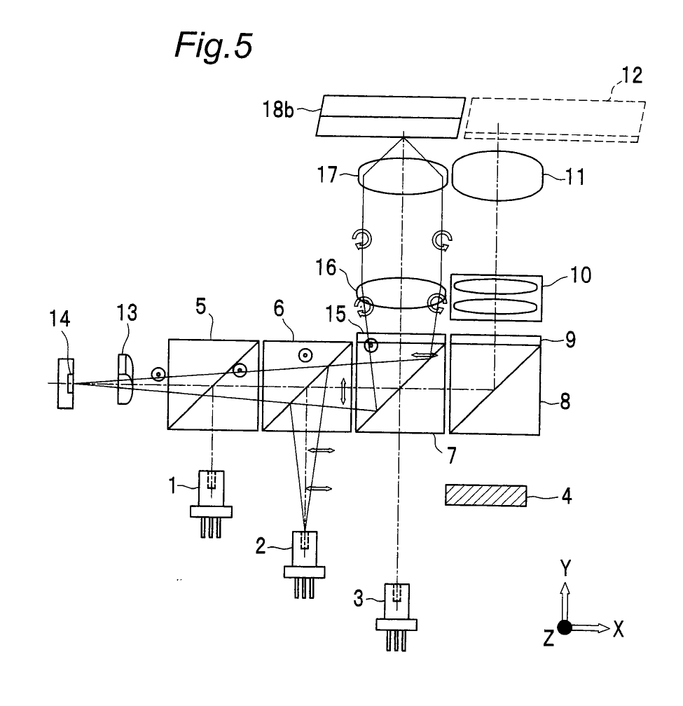

FIG. 5 is a view explaining the operation involving DVDs. In FIG. 5, a luminous flux outgoing from the red laser emitting device 2, which is a P wave relative to the red PBS 6, is reflected by the red PBS 6 and is reflected again by the blue-violet PBS 7. Then, as with the case of the HD-DVD, the luminous flux is converted into a circularly polarized beam by the quarter-wave plate 15, and becomes a parallel beam in the collimate lens 16, before being applied to a DVD disc 18b via the diffractive object lens 17, where write or read access of a signal is performed.

The reason why the luminous flux is guided to both the HD-DVD disc 18a and the DVD disc 18b by the same diffractive object lens 17 is because the thickness of the protective layer in both the HD-DVD disc 18a and the DVD disc 18b is about 0.6 mm, and so the diffractive object lens 17 can be designed easily. As a result, in the present embodiment, only the objective lens 11 can be set as a lens dedicated for BDs, while a common diffractive object lens 17 can be used for other discs including HD-DVDs, DVDs and CDs.

Further, as with the case of the HD-DVD, the reflected light beam from the DVD disc 18b with the rotation direction of being reverse to the direction before the reflection is converted from the circularly polarized beam into a linearly polarized beam by the quarter-wave plate 15, and comes incident into the blue-violet PBS 7 as an S wave. It is to be noted that the direction of the linearly polarization in this case is different from the direction of the original linearly polarized beam (at the time of incident) by 90 degrees. Then, the light beam which was incident into the blue-violet PBS 7 is reflected by the blue-violet PBS 7, and passes through the red PBS 6 and the infrared PBS 5, before going to a cylindrical lens 13, where a focus error signal is generated, and to a light receiving element 14, where an RF signal, a tracking error signal and a focus error signal are detected.

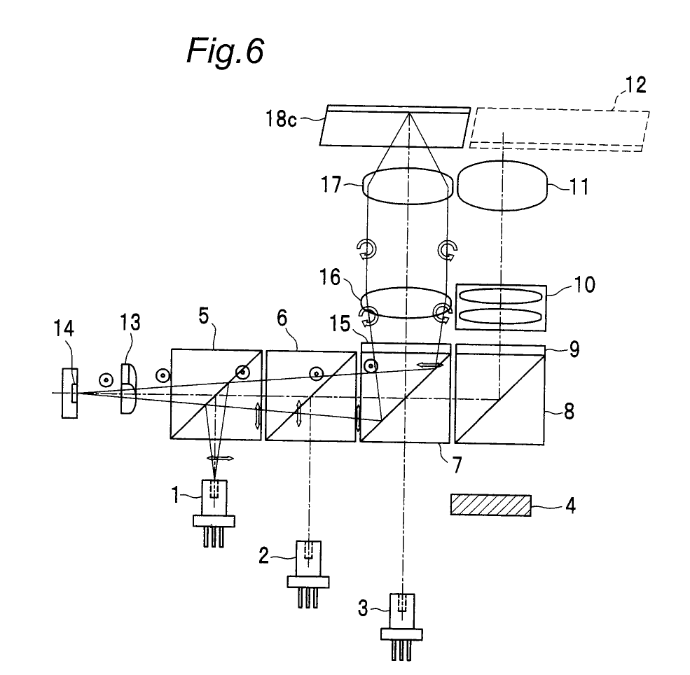

FIG. 6 is a view explaining the operation involving CDs. In FIG. 6, a luminous flux outgoing from the infrared laser emitting device 1, which is a P wave relative to the infrared PBS 5, is reflected by the infrared PBS 5, passes through the red PBS 6, and is reflected again by the blue-violet PBS 7. Then, as with the case of the HD-DVD, the luminous flux is converted into a circularly polarized beam by the quarter-wave plate 15, and becomes a parallel beam in the collimate lens 16, before being applied to a CD disc 18c via the diffractive object lens 17, where write or read access of a signal is performed.

Further, as with the case of the HD-DVD, the reflected light beam from the CD disc 18c with the rotation direction of the circularly polarized beam being reverse to the direction before the reflection is converted from the circularly polarized beam into a linearly polarized beam by the quarter-wave plate 15, and comes incident into the blue-violet PBS 7 as an S wave. It is to be noted that the direction of the linearly polarization in this case is different from the direction of the original linearly polarized beam (at the time of incident) by 90 degrees. Then, the light beam which was incident into the blue-violet PBS 7 is reflected by the blue-violet PBS 7, and passes through the red PBS 6 and the infrared PBS 5, before going to a cylindrical lens 13, where a focus error signal is generated, and to a light receiving element 14, where an RF signal, a tracking error signal and a focus error signal are detected.

As is described above, in the present embodiment, the half-wave plate 4 can be inserted into and extracted from the luminous flux between the blue-violet laser emitting device 3 and the blue-violet PBS 7 depending on the BD disc 12 and the HD-DVD disc 18a. Therefore, the polarization direction of the emitted light from the blue-violet laser emitting device 3 can be changed by the insertion and extraction of the half-wave plate 4, so that the blue-violet PBS 7 can split the emitted light into the optical path which goes to the BD disc 12 and the optical path which goes to the HD-DVD disc 18a. In this way, write or read access of a signal to the BD disc 12 and the HD-DVD disc 18a can be performed with use of only one blue-violet laser emitting device 3.

The blue-violet PBS 7 has a dichroic function for infrared and red colors. Therefore, the blue-violet PBS 7 in combination with the half-wave plate 4 which can be inserted into and extracted from the luminous flux coming from the blue-violet laser emitting device 3 allows the same three-wavelength optical pickup device to record information on and reproduce information from all the discs of CDs, DVDs, HD-DVDs, and BDs.

Moreover, if the plate glass or the plate resin 4 having a thickness optically equivalent to the half-wave plate 4 is simultaneously inserted when the half-wave plate 4 is removed from the luminous flux coming from the blue-violet laser emitting device 3, a stable and sufficient condensing spot can be obtained regardless of the presence of the half-wave plate 4 without changing the designed thickness (i.e., aberration correction amount) of the cover glass of the collimate lens 16.

In that case, any appropriate structure can be used for the half-wave plate moving mechanism (not shown) which inserts and extracts the half-wave plate 4 and the plate moving mechanism (not shown) which inserts and extracts the plate glass or plate resin 4a. For example, the mechanisms may be structured so that when it is detected that the BD disc 12 has been loaded, the plate glass or plate resin 4a is extracted by the plate moving mechanism while the half-wave plate 4 is inserted by the half-wave plate moving mechanism, whereas when it is detected that the HD-DVD disc 18a has been loaded, the half-wave plate 4 is extracted by the half-wave plate moving mechanism while the plate glass or plate resin 4a is inserted by the plate moving mechanism.

Moreover, the luminous flux emitted from the blue-violet laser emitting device 3, which is a P wave relative to the blue-violet PBS 7, is subjected to 90 degree rotation of its polarization direction by the half-wave plate 4 so that it is incident into the blue-violet PBS 7 as an S wave, and is reflected by the PBS surface of the blue-violet PBS 7. Further, the luminous flux emitted from the blue-violet laser emitting device 3, which is a P wave relative to the blue-violet PBS 7, is made incident into the blue-violet PBS 7 as a P wave without changing the polarization direction, so that it passes through the blue-violet PBS 7 as a P wave. In this way, the stable splitting characteristics by the blue-violet PBS 7 can be achieved by making the blue-violet PBS 7 reflect an S wave while making the blue-violet PBS 7 transmit a P wave.

It is to be noted that in the present embodiment, the direction of the linearly polarization of the emitted light from the blue-violet laser emitting device 3 is so set as to be the P wave relative to the blue-violet PBS 7. However, the present invention is not limited to this setting and so the direction of the linearly polarization of emitted light can be so set as to be the S wave relative to the blue-violet PBS 7. However, in that case, the extraction and insertion of the half-wave plate 4 regarding BDs and HD-DVDs need to be reversed from those in FIGS. 1 and 3, i.e., the half-wave plate 4 needs to be extracted in the case of BDs, while the half-wave plate 4 needs to be inserted in the case of HD-DVDs so that the luminous flux is guided to the objective lens 11 and the diffractive object lens 17. In this way, the blue-violet PBS 7 can reflect the S wave while transmitting the P wave, by which the stable splitting characteristics by the blue-violet PBS 7 can be achieved.

### Second Embodiment

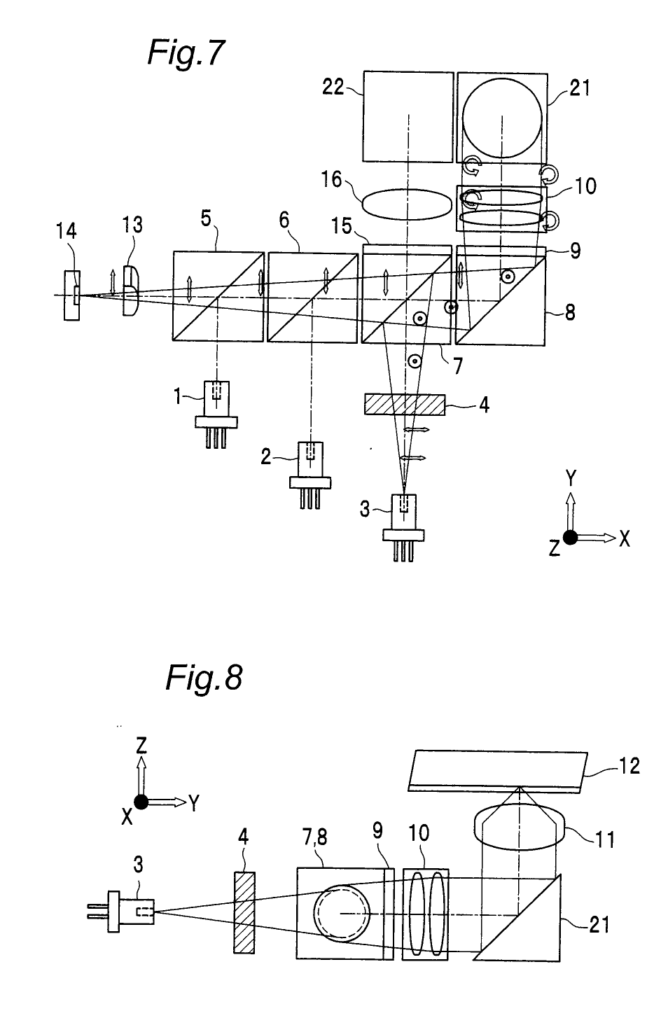

FIGS. 7 and 8 are views showing the structure of an optical pickup device of the present embodiment. The optical pickup device in the present embodiment has rising mirrors 21 and 22, but other structural aspects are identical to those in the first embodiment and therefore are designated by the reference numerals identical to those in the first embodiment.

FIGS. 7 and 8 show the operation involving BDs, in which FIG. 7 is a plan view and FIG. 8 is a side view. As with the case of the first embodiment, a luminous flux outgoing from the blue-violet laser emitting device 3, which is a P wave relative to the blue-violet PBS 7, travels through the half-wave plate 4, the blue-violet PBS 7, the total reflection mirror 8 and the quarter-wave plate 9 before coming incident into the collimate lens 10 having an aberration correcting function, and passes through the collimate lens 10 to become a parallel beam. Then, the parallel beam is reflected at generally right angles by the rising mirror 21, and is applied to the BD disc 12 via the objective lens 11, by which write or read access of a signal is performed.

Further, the reflected light beam from the BD disc 12 is made incident into the blue-violet PBS 7 through the route reverse to the previous route, and the light beam which passed through the blue-violet PBS 7 then passes through the red PBS 6 and the infrared PBS 5, before being incident into the cylindrical lens 13.

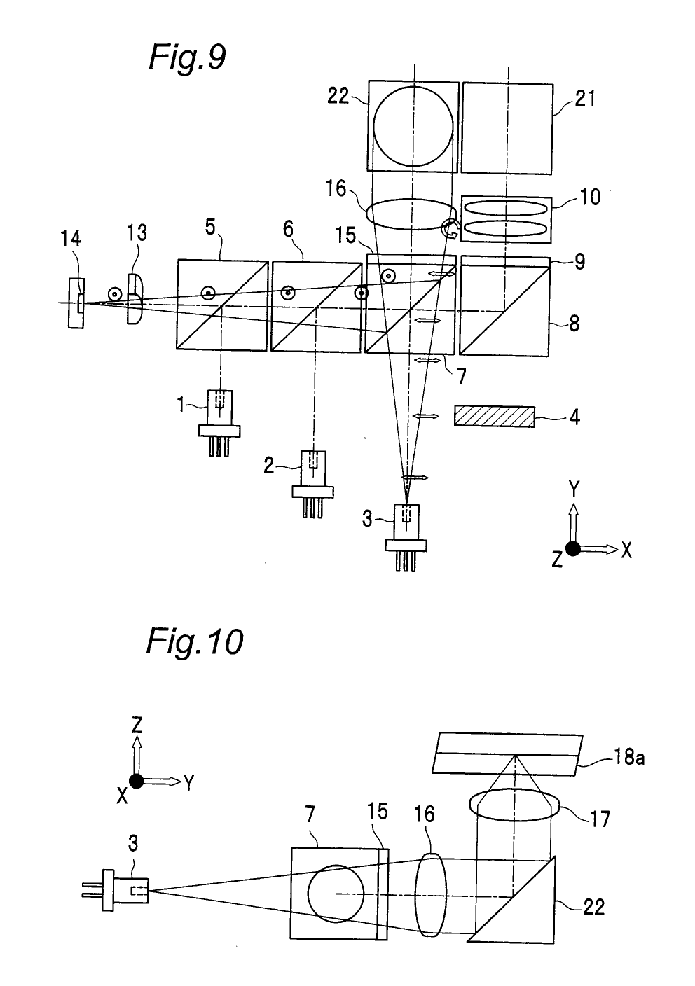

FIGS. 9 and 10 are explanatory views of the operation involving HD-DVDs, in which FIG. 9 is a plane view and FIG. 10 is a side view. In FIGS. 9 and 10, as with the case of the first embodiment, a luminous flux outgoing from the blue-violet laser emitting device 3, which is a P wave relative to the blue-violet PBS 7, travels through the blue-violet PBS 7 and the quarter-wave plate 15 before being incident into the collimate lens 16, through which the luminous flux becomes a parallel beam. Then, the parallel beam is reflected at generally right angles by the rising mirror 22 and is applied to the HD-DVD disc 18a via the diffractive object lens 17, by which write or read access of a signal is performed.

Further, the reflected light beam from the HD-DVD disc 18a is incident into the blue-violet PBS 7 through the route reverse to the previous route, and the light beam reflected by the blue-violet PBS 7 then passes through the red PBS 6 and the infrared PBS 5, before being incident into the cylindrical lens 13.

The operation involving DVDs and CDs is also performed according to the operation involving HD-DVDs shown in FIGS. 9 and 10 as with the case of the first embodiment.

Thus, in the present embodiment, the parallel beam which passed through the collimate lenses 10 and 16 is reflected at generally right angles by the rising mirrors 21 and 22, respectively. Therefore, when the BD disc 12 and the HD-DVD, DVD, and CD discs 18a, 18b and 18c are horizontally placed, the height of the optical pickup device of the present embodiment is defined by the height of the rising mirror 21 (or the rising mirror 22), and the thickness of the objective lens 11 (or the diffractive object lens 17). Therefore, the height can be made sufficiently small as compared with the height of the optical pickup device of the first embodiment which is defined by the height of the total reflection mirror 8, the thickness of the quarter-wave plate 9, the thickness of the collimate lens 10 and the thickness of the objective lens 11.

In this case, the rising mirror 21 and the rising mirror 22 do not have polarization characteristics and therefore have transmission and reflection characteristics unaffected by the polarization direction. Consequently, even if the rising mirrors 21 and 22 are inserted, completely the same optical property as in the case of the first embodiment can be presented.

As a result, according to the present embodiment, it becomes possible to reduce the thickness of the optical pickup device.

### Third Embodiment

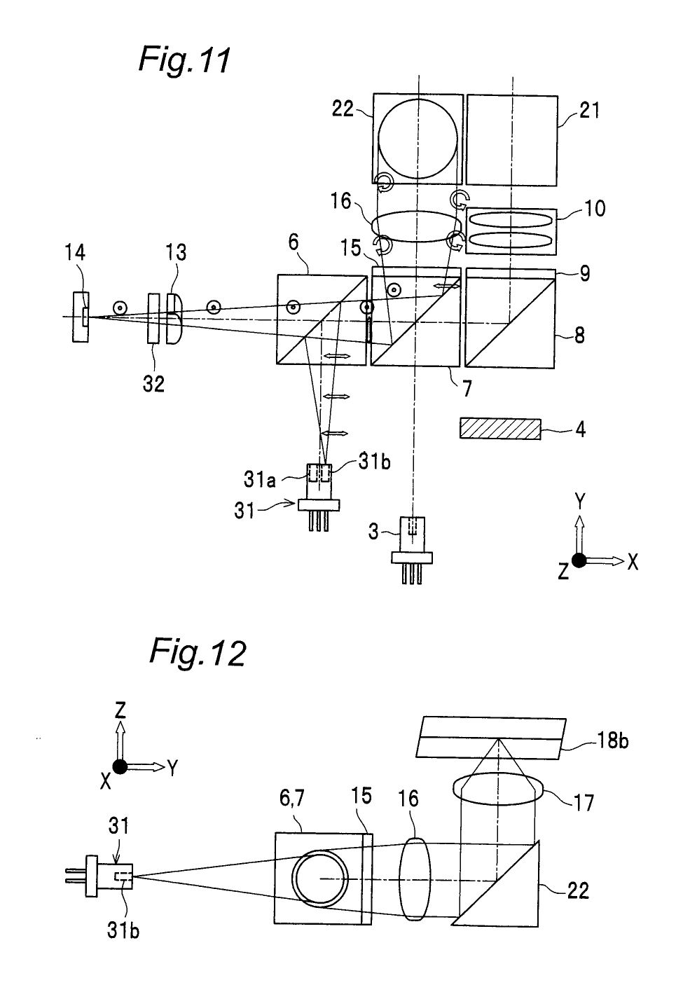

FIGS. 11 and 12 are views showing the structure of an optical pickup device of the present embodiment. The optical pickup device in the present embodiment uses a two-wavelength laser emitting device 31 for CDs and DVDs instead of the infrared laser emitting device 1 and the red laser emitting device 2 in the second embodiment. Other structural aspects are identical to those in the second embodiment and are therefore designated by the reference numerals identical to those in the second embodiment. However, in the present embodiment, the infrared PBS 5 is removed along with the removal of the infrared laser emitting device 1, and a diffractive coaxial element 32 is placed between the cylindrical lens 13 and the light receiving element 14.

FIGS. 11 and 12 show the operation involving DVDs, in which FIG. 11 is a plan view and FIG. 12 is a side view. A luminous flux emitted from a red laser 31b in the two-wavelength laser emitting device 31 is reflected by the red PBS 6 and is again reflected by the blue-violet PBS 7. Then, the luminous flux is converted into a circularly polarized beam by the quarter-wave plate 15, and is turned into a parallel beam in the collimate lens 16. The parallel beam is reflected at generally right angles by the rising mirror 22, and is applied to the DVD disk 18b via the diffractive object lens 17, by which write or read access of a signal is performed.

Further, the reflected light beam from the DVD disc 18b is made incident into the blue-violet PBS 7 through a route reverse to the previous route, and the light beam reflected by the blue-violet PBS 7 passes through the red PBS 6 and comes incident into the cylindrical lens 13, where a focus error signal is generated. Then, the light beam is guided by the diffractive coaxial element 32 to the light receiving element 14, where an RF signal, a tracking error signal and a focus error signal are detected.

In the operation involving CDs, a luminous flux emitted from an infrared laser 31a in the two-wavelength laser emitting device 31 is reflected by the red PBS 6 and then operates in a way similar to the case involving DVDs described above. Moreover, the operation corresponding to BDs and HD-DVDs is similar to the operation as in the case of the second embodiment.

Thus, in the present embodiment, the two-wavelength laser emitting device 31 incorporating the infrared laser 31a and red laser 31b is used. Therefore, in the present embodiment, the infrared laser emitting device 1 and the infrared PBS 5 can be removed, so that reduction in parts count and high-reliability can be achieved.

### Fourth Embodiment

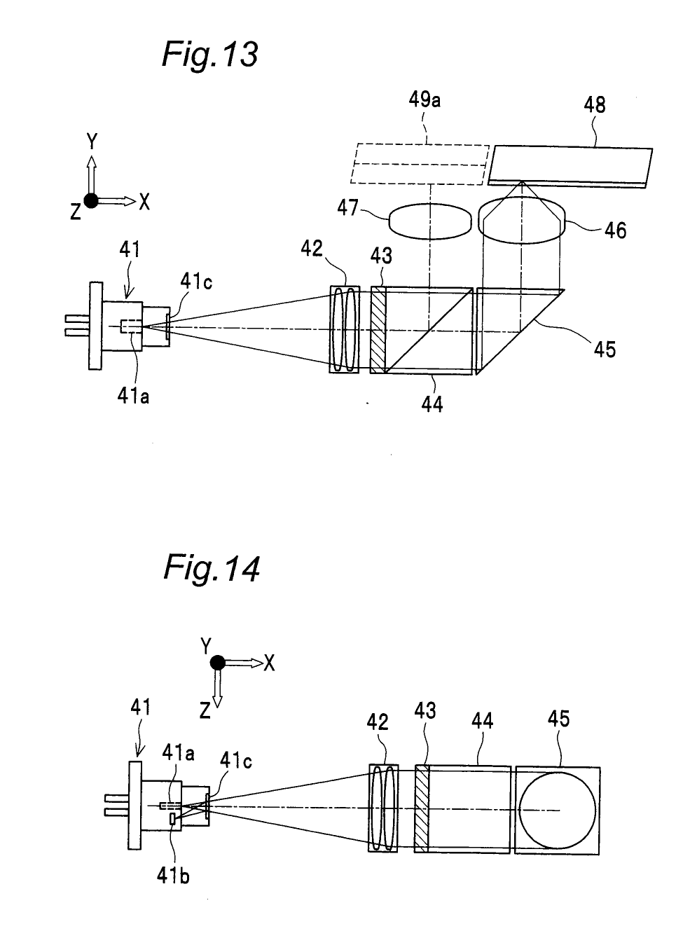

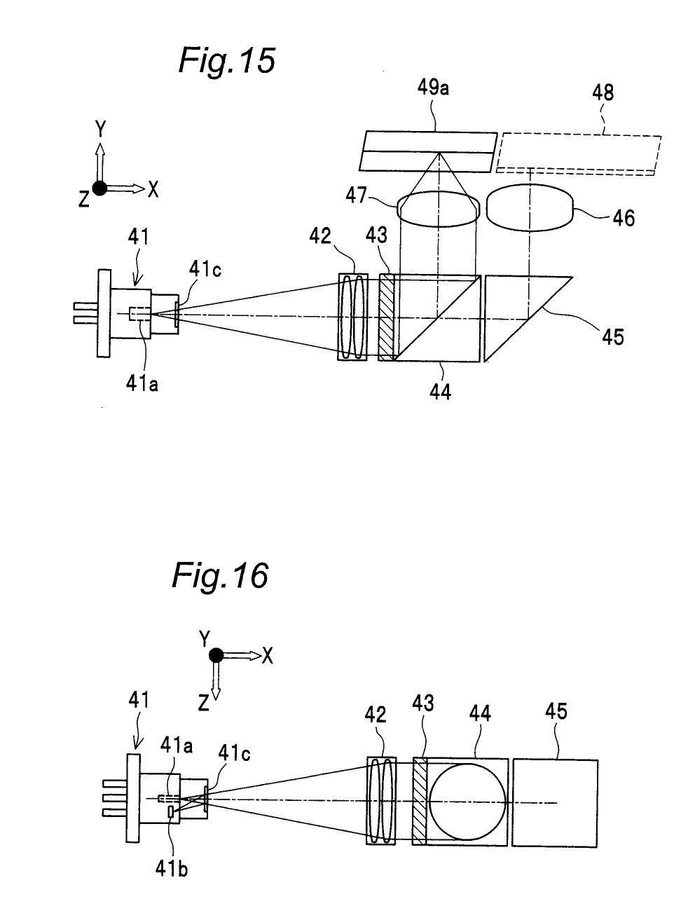

FIGS. 13 through 16 are views showing the structure of an optical pickup device of the present embodiment. The present embodiment relates to an optical pickup device which can support a BD disc 48 and a HD-DVD disc 49a. FIGS. 13 and 15 are side views of the optical pickup device. FIGS. 14 and 16 are plan views.

In FIGS. 13 through 16, there is a blue-violet hologram laser emitting device 41 having a blue-violet laser 41a, a light receiving element 41b, and a hologram element 41c. Also, there are a collimate lens 42 having an aberration correcting function, a quarter-wave plate 43, a half mirror 44 which splits a light beam into a transmitted light beam and a reflected light beam generally in half, a total reflection mirror 45, an objective lens 46, and a diffractive object lens 47. Herein, the half mirror 44 and the total reflection mirror 45 do not have polarization characteristics and therefore have transmission and reflection characteristics unaffected by the polarization direction.

In the above structure, in the case of recording information on and reproducing information from BD discs, as shown in FIGS. 13 and 14, a blue-violet laser beam emitted from the blue-violet laser 41a of the blue-violet hologram laser emitting device 41 is turned into a parallel beam in the collimate lens 42, and is converted into a circularly polarized beam by the quarter-wave plate 43. The circularly polarized beam then passes through the half mirror 44, and is reflected by the total reflection mirror 45, before being applied to the BD disc 48 via the objective lens 46. The reflected light beam from the BD disc 48 travels through a route reverse to the previous route, and is incident into the hologram element 41c of the blue-violet hologram laser emitting device 41. Then, a primary diffracted light beam diffracted by the hologram element 41c is received by the light receiving element 41b of the blue-violet hologram laser emitting device 41.

In the case of recording information on and reproducing information from HD-DVD discs, as shown in FIGS. 15 and 16, a blue-violet laser beam emitted from the blue-violet laser 41a of the blue-violet hologram laser emitting device 41 is turned into a parallel beam in the collimate lens 42, and is converted into a circularly polarized beam by the quarter-wave plate 43. The circularly polarized beam is then reflected by the half mirror 44, and is applied to the HD-DVD disc 49a via the diffractive object lens 47. The reflected light beam from the HD-DVD disc 49a travels through a route reverse to the previous route, and is incident into the hologram element 41c of the blue-violet hologram laser emitting device 41. Then, a primary diffracted light beam diffracted by the hologram element 41c is received by the light receiving element 41b of the blue-violet hologram laser emitting device 41.

As described above, in the present embodiment, the luminous flux is made to rise by the half mirror 44 and the total reflection mirror 45. Therefore, as with the case of the second embodiment, it becomes possible to reduce the thickness of the optical pickup device. Further, since the blue-violet hologram laser emitting device 41 having the blue-violet laser 41a, the light receiving element 41b and the hologram element 41c is used, it is not necessary to individually provide a blue-violet laser emitting device and a light receiving element. Therefore, the part count can be reduced to simplify the structure.

It is to be noted that in the above structure, the arrangement of the objective lens 46 for the BD disc 48 and the diffractive object lens 47 for the HD-DVD discs 49a can be exchanged. In that case, the installed position of the BD disc 48 and the HD-DVD disc 49a is also reversed. The arrangement of the objective lens 46 and the diffractive object lens 47 should appropriately be selected corresponding to the structure of the actuator in the optical pickup device. In that case, any arrangements can provide the optical pickup device having simplified structure.

### Fifth Embodiment

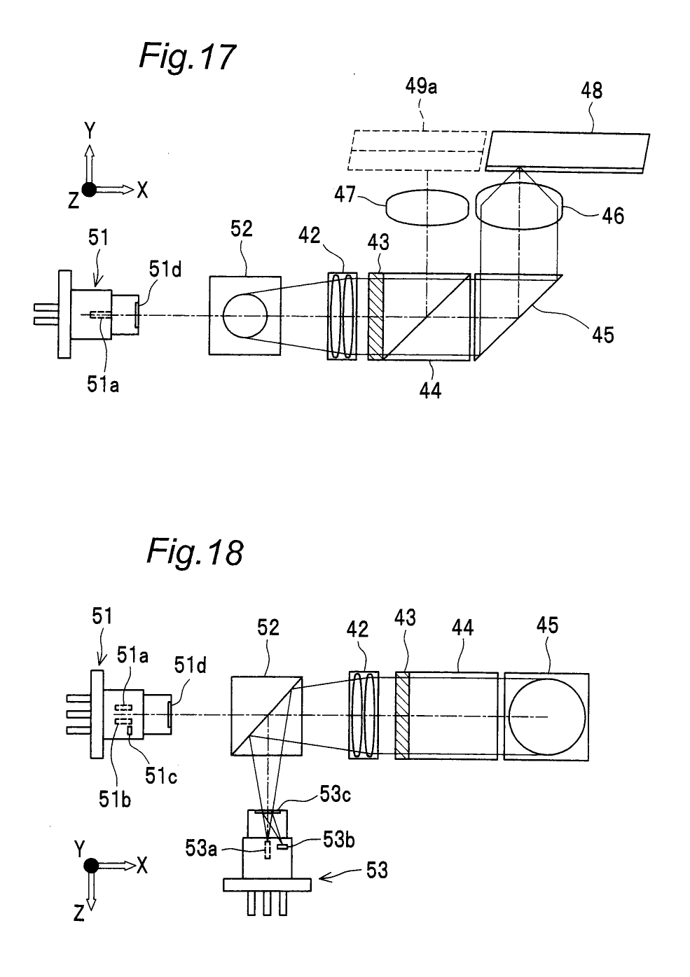

FIGS. 17 through 24 are views showing the structure of an optical pickup device of the present embodiment. The present embodiment relates to an optical pickup device capable of recording information on and reproducing from four kinds of discs with three wavelengths by employing a DB objective lens for BD discs only and employing a diffractive lens which can support both DVDs and CDs as a HD-DVD objective lens. FIGS. 17, 19, 21 and 23 are vertical cross-sectional views of the optical pickup device, while FIGS. 18, 20, 22, and 24 are plan views.

As shown in FIGS. 17 and 18 in the present embodiment, a red and infrared two-wavelength hologram laser emitting device 51 having an infrared laser 51a, a red laser 51b, a light receiving element 51c and a hologram element 51d is placed in the position of the blue-violet hologram laser emitting device 41 in the fourth embodiment. Between the red and infrared two-wavelength hologram laser emitting device 51 and a collimate lens 42 having an aberration correcting function, a blue-violet PBS 52 which is a prism having a PBS function in a blue-violet wavelength band and a dichroic function for infrared and red colors is placed, and a blue-violet hologram laser emitting device 53 having an optical axis, which perpendicularly intersects the optical axis of the red and infrared two-wavelength hologram laser emitting device 51 in the position of the blue-violet PBS 52, is placed in the position facing the blue-violet PBS 52. Other structural aspects are identical to those in the fourth embodiment and are therefore designated by the reference numerals identical to those in the fourth embodiment.

In the above structure, in the case of recording information on and reproducing information from BD discs, as shown in FIGS. 17 and 18, a blue-violet laser beam emitted from the blue-violet laser 53a of the blue-violet hologram laser emitting device 53 is reflected by the blue-violet PBS 52 and turned into a parallel beam in the collimate lens 42, before being converted into a circularly polarized beam by the quarter-wave plate 43. The circularly polarized beam then passes through the half mirror 44, and is reflected by the total reflection mirror 45, before being applied to a BD disc 48 via the objective lens 46. Further, the reflected light beam from the BD disc 48 travels through a route reverse to the previous route, and is incident into the hologram element 53c of the blue-violet hologram laser emitting device 53. Then, a primary diffracted light beam diffracted by the hologram element 53c is received by the light receiving element 53b of the blue-violet hologram laser emitting device 53.

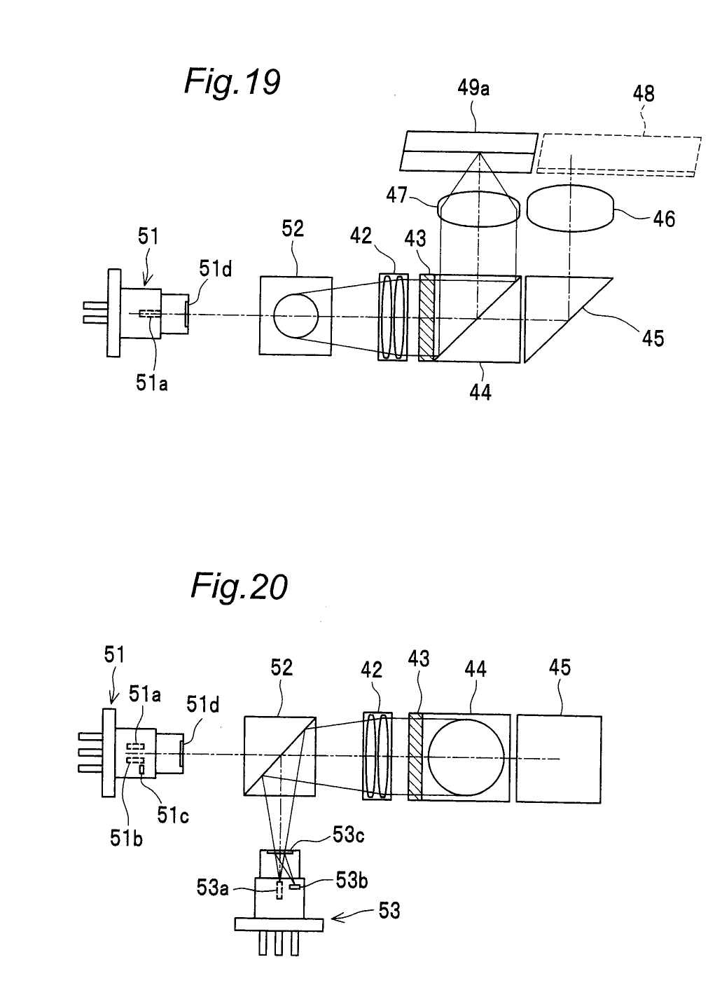

In the case of recording information on and reproducing information from HD-DVD discs, as shown in FIGS. 19 and 20, a blue-violet laser beam emitted from the blue-violet laser 53a of the blue-violet hologram laser emitting device 53 is reflected by the blue-violet PBS 52 and is turned into a parallel beam in the collimate lens 42, before being converted into a circularly polarized beam by the quarter-wave plate 43. The circularly polarized beam is then reflected by the half mirror 44, and is applied to a HD-DVD disc 49a via the diffractive object lens 47. Further, the reflected light beam from the HD-DVD disc 49a travels through a route reverse to the previous route, and is incident into the hologram element 53c of the blue-violet hologram laser emitting device 53. Then, a primary diffracted light beam diffracted by the hologram element 53c is received by the light receiving element 53b of the blue-violet hologram laser emitting device 53.

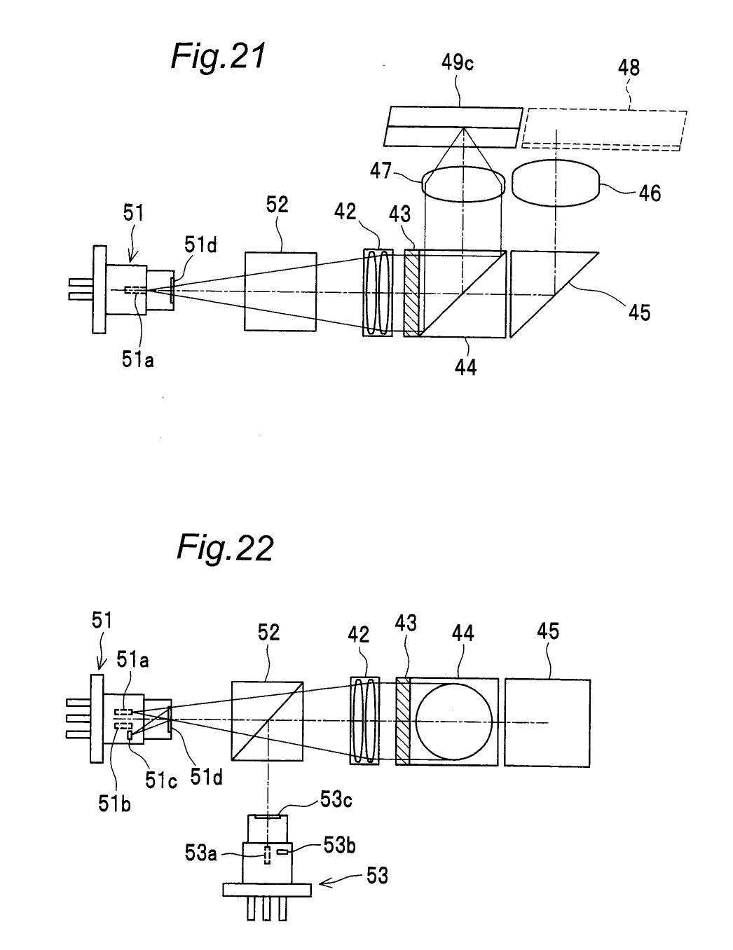

In the case of recording information on and reproducing information from CD discs, as shown in FIGS. 21 and 22, an infrared laser beam emitted from the infrared laser 51a of the red and infrared two-wavelength hologram laser emitting device 51 passes through the blue-violet PBS 52 and is turned into a parallel beam in the collimate lens 42, before being converted into a circularly polarized beam by the quarter-wave plate 43. The circularly polarized beam is then reflected by the half mirror 44, and is applied to a CD disc 49c via the diffractive object lens 47. The reflected light beam from the CD disc 49c travels through a route reverse to the previous route, and is incident into the hologram element 51d of the red and infrared two-wavelength hologram laser emitting device 51. Then, a primary diffracted light beam diffracted by the hologram element 51d is received by the light receiving element 51c of the red and infrared two-wavelength hologram laser emitting device 51.

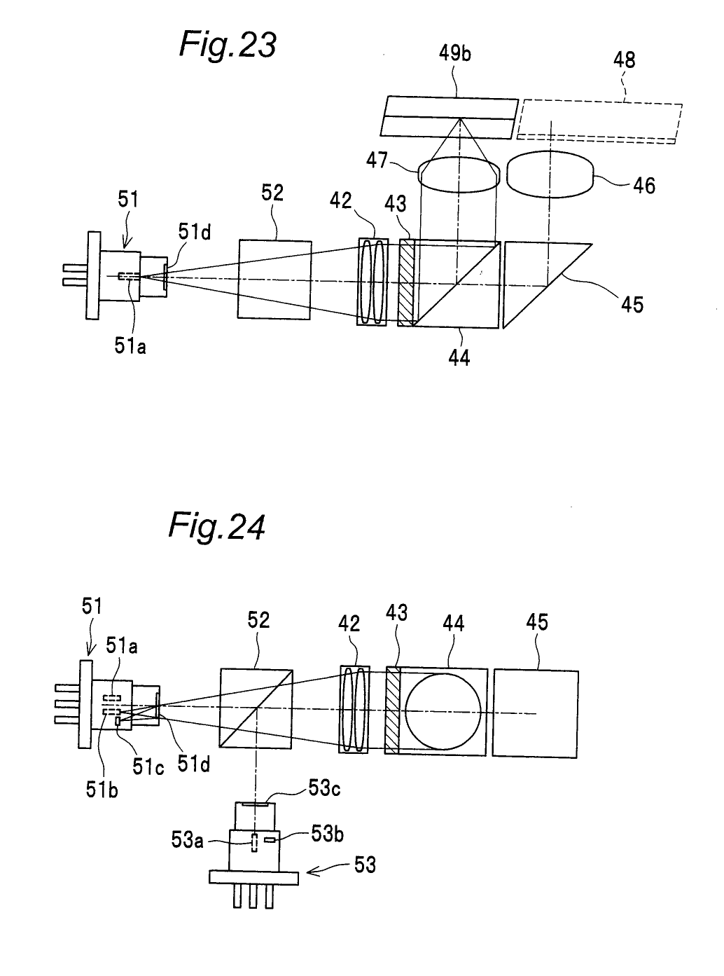

In the case of recording information on and reproducing information from DVD discs, as shown in FIGS. 23 and 24, a red laser beam emitted from the red laser 51b (not visible as it is behind the infrared laser 51a in FIG. 23) of the red and infrared two-wavelength hologram laser emitting device 51 passes through the blue-violet PBS 52 and is turned into a parallel beam in the collimate lens 42, before being converted into a circularly polarized beam by the quarter-wave plate 43. The circularly polarized beam is then reflected by the half mirror 44, and is applied to a DVD disc 49b via the diffractive object lens 47. Further, the reflected light beam from the DVD disc 49b travels through a route reverse to the previous route, and is incident into the hologram element 51d of the red and infrared two-wavelength hologram laser emitting device 51. Then, a primary diffracted light beam diffracted by the hologram element 51d is received by the light receiving element 51c of the red and infrared two-wavelength hologram laser emitting device 51.

As mentioned above, according to the present embodiment, the red and infrared two-wavelength hologram laser emitting device 51, the blue-violet hologram laser emitting device 53, a pair of the objective lenses 46 and 47, and the half mirror 44 and the total reflection mirror 45 which guide luminous flux to a pair of the objective lenses 46 and 47 are provided, so that it becomes possible to support four kinds of discs with three wavelengths without the need of complicated structure as in the first embodiment.

Further, since the objective lens 46 corresponding to the BD was set for BD discs only and the objective lens 47 corresponding to HD-DVDs was constituted of a diffractive lens which can support three kinds of discs including HD-DVDs, DVDs and CDs, an optical system can be composed of low-cost objective lenses corresponding to the thickness of the cover layer of the discs.

Although the ratio of reflection to transmission of the half mirror 44 is set as 1 to 1 in the present embodiment, the present invention is not limited to this ratio. In the case where either the BD or the HD-DVD requires only the power for reproduction, or in the case where it is desired to give priority to the reproduction performance of either the BD or the HD-DVD, changing the ratio of the reflection to transmission in the half mirror 44 makes it possible to set a ratio of power allotted to the BD side to the power allotted to the HD-DVD side at, for example, 7 to 3.

### Sixth Embodiment

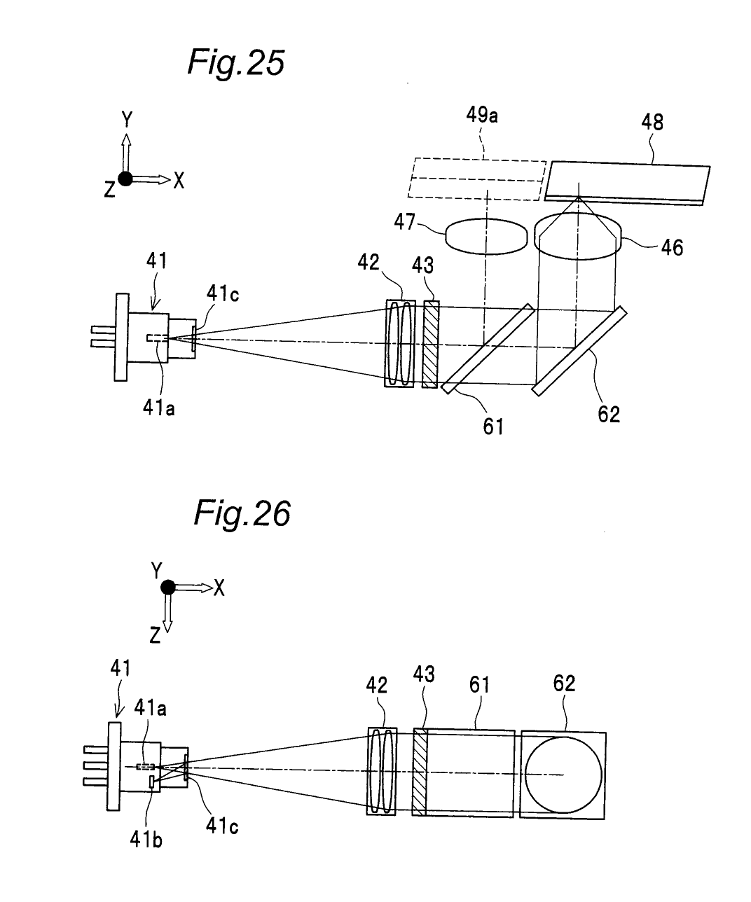

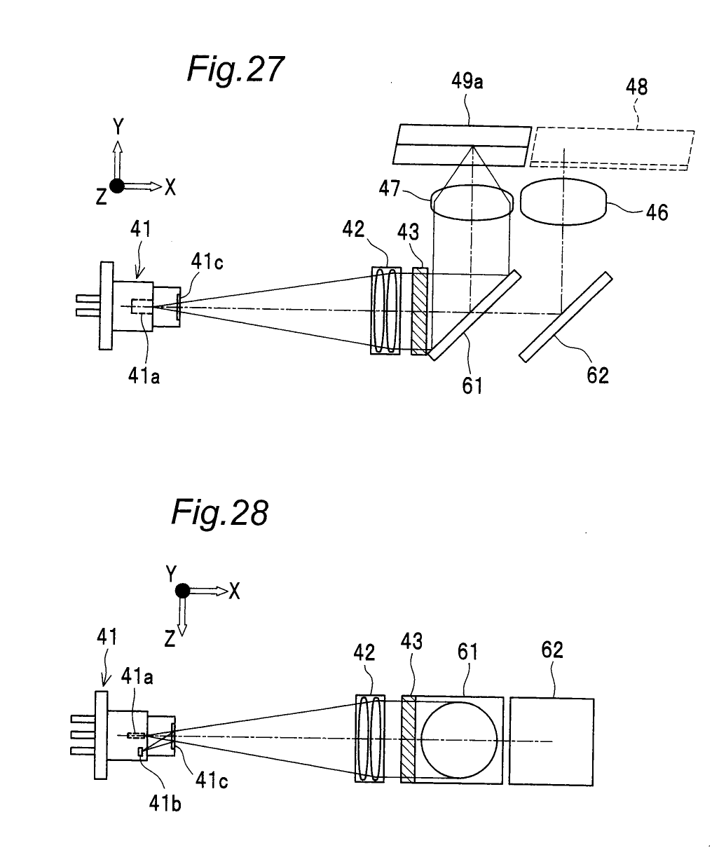

FIGS. 25 through 28 are views showing the structure of an optical pickup device of the present embodiment. The present embodiment relates to an optical pickup device in which the half mirror 44 and the total reflection mirror 45 in the fourth embodiment are constituted from a flat half mirror 61 and a total reflection flat mirror 62 which are plate components. FIGS. 25 and 27 are vertical cross-sectional views of the optical pickup device. FIGS. 26 and 28 are plan views.

In the above structure, in the case of recording information on and reproducing information from BD discs, as shown in FIGS. 25 and 26, a blue-violet laser beam emitted from the blue-violet laser 41a of the blue-violet hologram laser emitting device 41 is turned into a parallel beam in the collimate lens 42, and is converted into a circularly polarized beam by the quarter-wave plate 43. The circularly polarized beam then passes through the flat half mirror 61, and is reflected by the total reflection flat mirror 46, before being applied to the BD disc 48 via the objective lens 46. Further, the reflected light beam from the BD disc 48 travels through a route reverse to the previous route, and is incident into the hologram element 41c of the blue-violet hologram laser emitting device 41. Then, a primary diffracted light beam diffracted by the hologram element 41c is received by the light receiving element 41b of the blue-violet hologram laser emitting device 41.

Moreover, in the case of recording information on and reproducing information from HD-DVD discs, as shown in FIGS. 27 and 28, a blue-violet laser beam emitted from the blue-violet laser 41a of the blue-violet hologram laser emitting device 41 is turned into a parallel beam in the collimate lens 42, and is converted into a circularly polarized beam by the quarter-wave plate 43. The circularly polarized beam is then reflected by the flat half mirror 61, and is applied to the HD-DVD disc 49a via the diffractive object lens 47. The reflected light beam from the HD-DVD disc 49a travels through a route reverse to the previous route, and is incident into the hologram element 41c of the blue-violet hologram laser emitting device 41. Then, a primary diffracted light beam diffracted by the hologram element 41c is received by the light receiving element 41b of the blue-violet hologram laser emitting device 41.

As mentioned above, according to the present embodiment, inexpensive plate components are used as the half mirror and the total reflection mirror. Therefore, it becomes possible to provide an inexpensive and stable optical pickup device.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical pickup device, comprising:
a first light source for emitting a first wavelength laser beam to a disc-shaped first recording medium which is subjected to recording and reproduction of information with the first wavelength laser beam;
a second light source for emitting a second wavelength laser beam to a disc-shaped second recording medium which is subjected to recording and reproduction of information with the second wavelength laser beam;
a third light source for emitting a third wavelength laser beam to a disc-shaped third recording medium which is subjected to recording and reproduction of information with the third wavelength laser beam and to a disc-shaped fourth recording medium which is subjected to recording and reproduction of information with the third wavelength laser beam;
a first optical system for guiding the first wavelength laser beam emitted from the first light source to the first recording medium;
a second optical system for guiding the second wavelength laser beam emitted from the second light source to the second recording medium;
a polarization beam splitter having a polarization beam splitting function for splitting the third wavelength laser beam and a dichroic function with wavelength selectivity for the first wavelength laser beam and the second wavelength laser beam, the polarization beam splitter splitting an optical path of the third wavelength laser emitted from the third light source into a first optical path going to the third recording medium and a second optical path going to the fourth recording medium; and
a polarizing orientation switchover element which is placed on an optical axis between the third light source and the polarization beam splitter for rotating a polarization direction of the third wavelength laser beam emitted from the third light source 90 degrees, and splitting a luminous flux of the third wavelength laser beam into either the first optical path or the second optical path with the polarization beam splitter,
wherein with light beams of three wavelengths including the first wavelength laser beam from the first light source, the second wavelength laser beam from the second light source and the third wavelength laser beam from the third light source, information can be recorded on and reproduced from four kinds of disc-shaped recording media including the first recording medium, the second recording medium, the third recording medium and the fourth recording medium.

2. The optical pickup device according to claim 1, comprising a polarizing orientation switchover element moving mechanism which inserts and extracts the polarizing orientation switchover element.

3. The optical pickup device according to claim 2, comprising:
a plate glass or a transparent plate resin which is placed on an optical axis between the third light source and the polarization beam splitter, and which has a thickness optically equivalent to the polarizing orientation switchover element; and
a plate moving mechanism for extractably inserting the plate glass or the transparent plate resin into a position where the polarizing orientation switchover element was present between the third light source and the polarization beam splitter after the polarizing orientation switchover element is extracted from the position blocking the optical axis.

4. The optical pickup device according to claim 2,
wherein the polarizing orientation switchover element is inserted by the polarizing orientation switchover element moving mechanism into a position blocking the optical axis between the third light source and the polarization beam splitter so as to rotate a polarization direction of the third wavelength laser beam emitted from the third light source 90 degrees,
wherein the polarization beam splitter splits the third wavelength laser beam with the polarization direction rotated 90 degrees by the polarizing orientation switchover element into the second optical path side which goes to the fourth recording medium, and
wherein the optical pickup device comprises an objective lens for the fourth recording medium for guiding a luminous flux of the third wavelength laser beam split to the second optical path side by the polarization beam splitter to the fourth recording medium, so that with the third wavelength laser beam emitted from the third light source, information is recorded on and reproduced from the fourth recording medium.

5. The optical pickup device according to claim 2,
wherein the polarizing orientation switchover element is extracted by the polarizing orientation switchover element moving mechanism from a position blocking the optical axis between the third light source and the polarization beam splitter so as to prevent a polarization direction of the third wavelength laser beam emitted from the third light source from changing,
wherein the polarization beam splitter splits the third wavelength laser beam with the polarization direction unchanged by the polarizing orientation switchover element into the first optical path side which goes to the third recording medium, and
wherein the optical pickup device comprises an objective lens for the third recording medium for guiding a luminous flux of the third wavelength laser beam split to the first optical path side by the polarization beam splitter to the third recording medium, so that with the third wavelength laser beam emitted from the third light source, information is recorded on and reproduced from the third recording medium.

6. The optical pickup device according to claim 2,
wherein the polarizing orientation switchover element is extracted by the polarizing orientation switchover element moving mechanism from a position blocking the optical axis between the third light source and the polarization beam splitter so as to prevent a polarization direction of the third wavelength laser beam emitted from the third light source from changing,
wherein the polarization beam splitter splits the third wavelength laser beam with the polarization direction unchanged by the polarizing orientation switchover element into the second optical path side which goes to the fourth recording medium, and
wherein the optical pickup device comprises an objective lens for the fourth recording medium for guiding a luminous flux of the third wavelength laser beam split to the second optical path side by the polarization beam splitter to the fourth recording medium, so that with the third wavelength laser beam emitted from the third light source, information is recorded on and reproduced from the fourth recording medium.

7. The optical pickup device according to claim 2,
wherein the polarizing orientation switchover element is inserted by the polarizing orientation switchover element moving mechanism into a position blocking the optical axis between the third light source and the polarization beam splitter so as to rotate a polarization direction of the third wavelength laser beam emitted from the third light source 90 degrees,
wherein the polarization beam splitter splits the third wavelength laser beam with the polarization direction rotated 90 degrees by the polarizing orientation switchover element into the first optical path side which goes to the third recording medium, and
wherein the optical pickup device comprises an objective lens for the third recording medium for guiding a luminous flux of the third wavelength laser beam split to the first optical path side by the polarization beam splitter to the third recording medium, so that with the third wavelength laser beam emitted from the third light source, information is recorded on and reproduced from the third recording medium.

8. The optical pickup device according to claim 1,
wherein the first wavelength laser beam from the first light source is an infrared laser beam,
the second wavelength laser beam emitted from the second light source is a red laser beam, and
the third wavelength laser beam emitted from the third light source is a blue-violet laser beam.

9. An optical pickup device, comprising:
a light source for emitting a blue-violet laser beam to a disc-shaped first recording medium which is subjected to recording and reproduction of information with the blue-violet laser beam and to a disc-shaped second recording medium which is subjected to recording and reproduction of information with the blue-violet wavelength laser beam;
a first objective lens for guiding the blue-violet laser beam emitted from the light source to the first recording medium;
a second objective lens for guiding the blue-violet laser beam emitted from the light source to the second recording medium;
a half mirror for splitting the blue-violet laser beam emitted from the light source into a first optical path in which the blue-violet laser beam passes toward the first objective lens side, and a second optical path in which the blue-violet laser beam is reflected toward the second objective lens; and
a reflective mirror for reflecting the blue-violet laser beam split to the first optical path side by the half mirror toward the first objective lens,
wherein with one wavelength of the blue-violet laser beam from the light source, information can be recorded on and reproduced from two kinds of disc-shaped recording media including the first recording medium and the second recording medium.

10. An optical pickup device, comprising:
a light source for emitting a blue-violet laser beam to a disc-shaped first recording medium which is subjected to recording and reproduction of information with the blue-violet laser beam and to a disc-shaped second recording medium which is subjected to recording and reproduction of information with the blue-violet wavelength laser beam;
a first objective lens for guiding the blue-violet laser beam emitted from the light source to the first recording medium;
a second objective lens for guiding the blue-violet laser beam emitted from the light source to the second recording medium;
a half mirror for splitting the blue-violet laser beam emitted from the light source into a first optical path in which the blue-violet laser beam passes toward the second objective lens side, and a second optical path in which the blue-violet laser beam is reflected toward the first objective lens; and
a reflective mirror for reflecting the blue-violet laser beam split to the first optical path side by the half mirror toward the second objective lens,
wherein with one wavelength of the blue-violet laser beam from the light source, information can be recorded on and reproduced from two kinds of disc-shaped recording media including the first recording medium and the second recording medium.

11. The optical pickup device according to claim 9,
wherein the first objective lens is an objective lens dedicated for the first recording medium, and
wherein the second objective lens is a diffractive object lens which can support the second recording medium, a disc-shaped third recording medium which has a thickest transparent cover at a side of signal reading and which is subjected to recording and reproduction of information with a infrared laser beam, and a disc-shaped fourth recording medium which has a transparent cover at a side of signal reading thinner than that of the third recording medium and which is subjected to recording and reproduction of information with a red laser beam.

12. The optical pickup device according to claim 10,
wherein the first objective lens is an objective lens dedicated for the first recording medium, and
wherein the second objective lens is a diffractive object lens which can support the second recording medium, a disc-shaped third recording medium which has a thickest transparent cover at a side of signal reading and which is subjected to recording and reproduction of information with a infrared laser beam, and a disc-shaped fourth recording medium which has a transparent cover at the side of signal reading thinner than that of the third recording medium and which is subjected to recording and reproduction of information with a red laser beam.

13. The optical pickup device according to claim 9,
wherein when a recording medium which is a destination of the blue-violet laser beam reflected by the half mirror is a recording medium for reproduction only and the other recording medium is a recording medium for reproduction and recording, the half mirror is so set that reflectance is lower than transmittance, and
wherein when a recording medium which is a destination of the blue-violet laser beam reflected by the half mirror is a recording medium for reproduction and recording and the other recording medium is a recording medium for reproduction only, the half mirror is so set that reflectance is higher than transmittance.

14. The optical pickup device according to claim 10,
wherein when a recording medium which is a destination of the blue-violet laser beam reflected by the half mirror is a recording medium for reproduction only and the other recording medium is a recording medium for reproduction and recording, the half mirror is so set that reflectance is lower than transmittance,
wherein when a recording medium which is a destination of the blue-violet laser beam reflected by the half mirror is a recording medium for reproduction and recording and the other recording medium is a recording medium for reproduction only, the half mirror is so set that reflectance is higher than transmittance.
